(19) United States
(12) Patent Application Publication
(10) Pub. No.: US 2012/0306823 A1
(43) Pub. Date: Dec. 6, 2012

(54) AUDIO SENSORS

(75) Inventors: Aleksandar Pance, Saratoga, CA (US); Brett Bilbrey, Sunnyvale, CA (US); Eric George Smith, Palo Alto, CA (US); Jahan Christian Minoo, San Jose, CA (US)

(73) Assignee: Apple Inc., Cupertino, CA (US)

(21) Appl. No.: 13/153,990

(22) Filed: Jun. 6, 2011

(51) Int. Cl. G06F 3/043

(52) U.S. Cl. 345/177

(57) ABSTRACT

One embodiment may take the form of an audio detection system having a display assembly. The display assembly may include a screen and at least one electromagnetic energy emitter configured to direct energy at an inside surface of the screen. At least one sensor is configured to sense the emitted energy after it is reflected from the inside surface of the screen and generate electrical signals corresponding the sensed reflected energy. A processor coupled to the at least one sensor generates an audio signal representative of sound waves that impact an outer surface of the screen.

### TECHNICAL FIELD

The present disclosure is generally related to audio sensors and, more specifically, to optically based audio sensors.

### BACKGROUND

Many modern electronic devices implement a wide variety of input and/or output (I/O) devices within a single housing to provide an enhanced user experience. The user experience may include functionality provided by the I/O devices, as well as an appearance of the device. Apertures formed in the housing of the device to allow sound waves to impact microphone diaphragms may detract from the visual appeal of the housing.

The positioning of microphones within a housing can in part determine the effectiveness of the microphones. For example, if microphones are positioned near noisy components such as near a keyboard or a central processing unit (CPU) or fan, the noise may make it difficult to discern other sounds, such as a user's speech. Additionally, microphones are generally more effective when they are near and/or aligned with the origin of the sounds that they are intended to detect.

### SUMMARY

One embodiment may take the form of an audio detection system having a display assembly. The display assembly may include a screen and at least one electromagnetic energy emitter configured to direct energy at an inside surface of the screen. At least one sensor is configured to sense the emitted energy after it is reflected from the inside surface of the screen and generate electrical signals corresponding the sensed reflected energy. A processor coupled to the at least one sensor generates an audio signal representative of sound waves that impact an outer surface of the screen.

Another embodiment may take the form of a computer system having a display that includes a screen having an interior surface and an exterior surface. The exterior surface is visible to a user. One or more sensors are coupled to the display and configured to detect vibrations of the screen generated by sound waves impacting the exterior surface of the screen. A processor in communication with the one or more sensors is configured to generate an output representative of sound waves.

Yet another embodiment may include a method of operating a computing device. The method includes obtaining an electrical signal corresponding to vibration of a screen of the computing device resulting from sound waves impacting the screen and filtering the signal to remove noise components. The method also includes generating an output signal representative of the sound waves that impacted the screen.

While multiple embodiments are disclosed, still other embodiments of the present invention will become apparent to those skilled in the art from the following Detailed Description. As will be realized, the embodiments are capable of modifications in various aspects, all without departing from the spirit and scope of the embodiments. Accordingly, the drawings and detailed description are to be regarded as illustrative in nature and not restrictive.

### BRIEF DESCRIPTION OF THE DRAWINGS

FIG. 1 illustrates a computing device having microphones associated with a display screen.

FIG. 2 is a block diagram of the computing device of FIG. 1.

FIG. 3 is a partial cross-sectional view of the display screen of FIG. 1 taken along line III-III, showing an emitter and sensor in a stack of a display of the computing device.

FIG. 4 is a partial cross-sectional view of the display screen of FIG. 1 taken along line III-III, showing an emitter and sensor outside the stack of the display of the computing device in accordance with an alternative embodiment.

FIG. 5 is a flowchart illustrating an example method for sensing sound using a screen as a diaphragm to modulate a carrier signal.

FIG. 6 is a partial exploded view of the display screen showing an array of emitters directed toward a center region of the screen.

FIG. 7 is a partial rear view showing multiple arrays of sensors and emitters positioned about a periphery of the screen 102.

FIG. 8 illustrates construction of a low frequency sine wave using signals received at different sensors in an array.

FIG. 9 is a partial cross-sectional view of the display screen of FIG. 1 taken along line III-III, showing a vibration sensor coupled to the screen of the computing device, in accordance with an alternative embodiment.

FIG. 10 is a partial cross-sectional view of the display screen of FIG. 1 taken along line III-III, showing a vibration sensor coupled to an element behind the display stack of the computing device in accordance with another alternative embodiment.

FIG. 11 is a partial rear view showing arrays of vibration sensors coupled to the screen of the computing device.

FIG. 12 is a partial rear view showing arrays of both vibration sensors coupled to the screen and emitters and sensors configured to sense vibration of the screen.

### DETAILED DESCRIPTION

Embodiments discussed herein relate to utilization of a display screen of an electronic device as a diaphragm for microphones. One embodiment may take the form of a light-based audio sensor that utilizes a display screen of a computing device in a manner similar to a diaphragm of a conventional microphone. Specifically, light may be directed at the screen and reflected back to one or more sensors. Sound waves impacting the screen may cause the screen to vibrate; these vibrations modulate the reflected light detected by the sensor(s). Hence, demodulation of the reflected light signals allows for generation of electrical signals that correspond to the sound waves.

In one embodiment, the light source for the sensor is located within a Z-stack of the display. For example, it may be located behind light elements that create lighted pixels of the display (e.g., liquid crystal elements that block or pass light). The light emitted from the light source may be directed at or near the center of the display screen and reflected back to one or more sensors also located in the Z-stack (for example, behind the light elements). In another embodiment, one or more light sources and sensors may be positioned adjacent to the display screen. The light sources may be, for example, laser diodes, light emitting diode (LEDs), or other suitable sources that provide a carrier wave. The carrier wave is modulated by vibrations of the screen and the modulated signal is received by the sensors.

The sensors generate electrical signals corresponding to the modulated signal. The electrical signals are demodulated to extract the sound wave information. The demodulation process may be performed in accordance with known demodulation techniques.

In some embodiments, an array of sensors is utilized. The array of sensors may detect a fuller spectrum of sound, as well as determine an impact location of sound waves through beam steering the sensed audio signal. That is, the array of sensors may reconstruct the sound spectrum by using a reverse phase array technique to discern low frequency signals or the direction of the sound.

In still other embodiments, direct vibration sensors may be implemented to sense vibrations of the screen. That is, sensors directly coupled to the screen to sense vibrations may be utilized. These sensed vibrations may be processed to generate a signal correlated to the sound waves that impact the screen. The vibration sensors may be utilized in combination with the light based sensors and/or other audio sensors, such as conventional condenser microphones.

The use of the glass screen of the display as a diaphragm may allow more sensitive audio sampling and allows for both phased array sampling and beamforming. Thus, a wider range of frequencies may be sampled at a higher quality with better noise reduction. Additionally, embodiments described herein may be able to identify a location of a sound source relatively accurately. Also, laser sampling may permit the display to be hermetically sealed. No opening would be necessary for detection of sound waves in contrast with conventional condenser microphones. “Laser sampling” as used herein may refer to using a laser or light to sample sound waves. One embodiment of laser sampling includes bouncing a laser off an interior of a screen, thereby modulating the laser with a screen movement occurring as the laser impacts the screen.

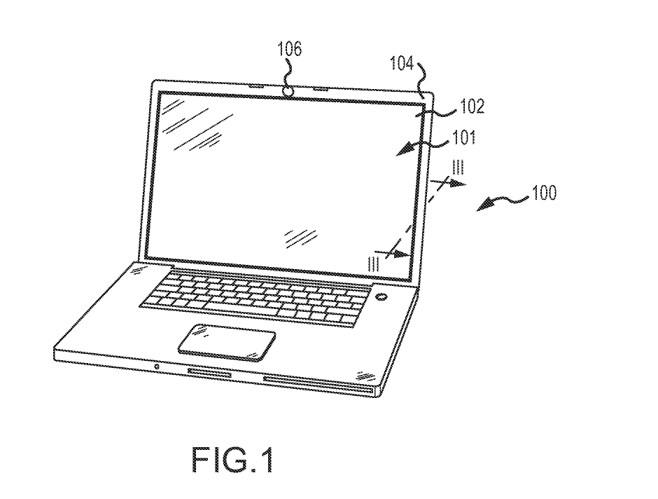

Turning to the drawings and referring initially to FIG. 1, a computing device 100 is illustrated. The computing device 100 includes a display 101 having a display screen 102 and a bezel 104 outlining the display screen. The display may implement any suitable display technology such, as liquid crystal display (LCD), LEDs, organic LEDs, plasma, or other technologies. One or more input/output (I/O) devices may be positioned within the bezel 104. For example, a camera 106 may be located in the bezel 104. Further, additional I/O devices may be obscured by the bezel.

It should be appreciated that, although FIG. 1 illustrates a notebook computing device, the present techniques may be applied to all suitable computing devices including desktop computing devices, tablet computing devices, mobile phones, smart phones, and so forth. Moreover, the present techniques may find application in other areas as well. For example, applications may be found in vehicles, helmets with heads-up displays, and/or televisions. As such, the specific embodiments discussed herein are not intended to be limiting.

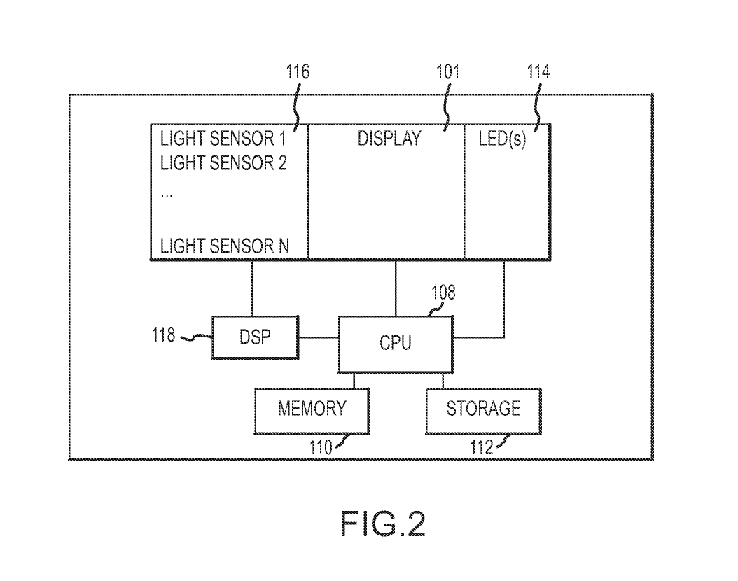

FIG. 2 is a block diagram of the computing device 100. As shown, the display 101 may be coupled to a processor 108. The processor 108 may be in communication with memory 110 and a storage device 112. The memory 110 generally may take any suitable form of execution memory, such as random access memory (RAM), dynamic RAM, synchronous dynamic RAM, and so forth. The storage device 112 may take the form of a hard disk drive, flash memory, magnetic tape storage, and/or the like.

The computing device 100 generally includes one or more emitters 114, such as lasers, LEDs, radio frequency (RF) emitters and so forth that may be implemented, along with appropriate sensors 116, to detect sounds. A digital signal processor (DSP) 118 may be coupled to the sensors 116 to process the sensor output and recreate sounds from the modulated light sensed by the sensors. The emitters 114 may be controlled by the processor 108 or, in some embodiments, by a separate controller (not shown).

The emitters 114 may emit a carrier signal of any suitable electromagnetic frequency. In some embodiments, they may be light emitters. That is, in some embodiments, the emitters 114 may operate in a visible or non-visible range of the electromagnetic spectrum, such as in the near infrared (IR) band, or the IR band. In still other embodiments, the emitters 114 may operate in other regions of the electromagnetic spectrum, such as the radio frequency (RF) band of the spectrum, for example. In some embodiments, a coating or film may be provided on an inside surface of the display screen 102 that allows for passage of visible light and reflects other frequency ranges (e.g., reflects RF, near IR, and so forth).

The sensors 116 may be arranged in any suitable manner to receive light emitted from the emitters 114 and reflected from the display 102. When reflected from the display 102, the light is modulated by the vibrations of the display screen 102. The display 101 of the computing device 100 generally is positioned to receive sound waves. For example, the display 101 is positioned to receive sound waves from a user speaking while positioned in front of the computing device, as the sound waves are directed at the display screen 102 and cause deflection/vibration of the screen.

The display screen 102 provides a large surface area to provide sensitivity to sound waves. The displacement of the display screen 102 in response to sound waves impacting the screen 102 modulates a carrier wave reflected therefrom which is received by the sensors 116.

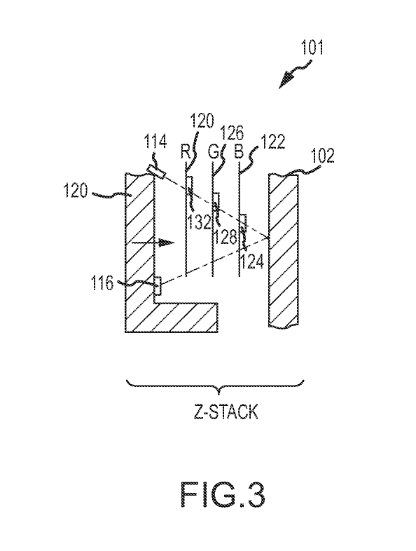

FIG. 3 is a partial cross-sectional view of the display 101 taken along line III-III of FIG. 1 showing the Z-stack for the display. The Z-stack may include the screen 102 and a light source 120 that projects light towards the screen to illuminate the one or more pixels of the display 101. The light may pass through red, green and blue (RGB) elements 124, 128 132 to generate colors for the display. It should be appreciated that, in an actual implementation, an array of RGB elements may be provided. Each RGB element may be provided with separate address lines 130, 126, 122 to control the light that passes through the elements. For example, the RGB elements 124, 128, 132 may be polarized elements configured to let light pass through or to occlude light based on signals provided by the address lines 130, 126, 122. The combination of the RGB elements 124, 128, 132 passing or occluding light allows for various colors and brightness levels for the display. Various other configurations/techniques may be implemented for the display 101.

The emitter 114 may also be included in the Z-stack of the display 101. For example, the emitter 114 may be positioned behind the RGB elements 124, 128, 132 and a beam emitted from the emitter may pass through spaces in between the RGB elements 124, 128, 132. The emitter 114 may be directed to or near the center of the screen 102 and reflect back to the light sensor 116 also positioned in the Z-stack behind the RGB elements 124, 128, 132. The light emitted by the emitter 114 serves as a carrier signal that is modulated by the movement of the screen 102.

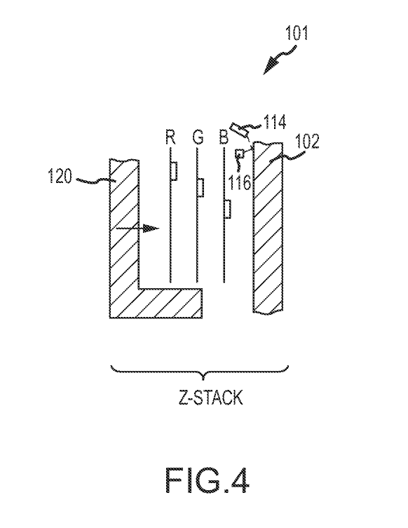

In some embodiments, the emitter 114 and the light sensor 116 may be positioned along the sides of the screen 102 in accordance with an alternative embodiment, as shown in FIG. 4. The positioning of the emitters 114 and sensors 116 near the edge of the screen 102 allows sampling of audio without having to go through the pixel region of the display 101. It should be appreciated that any suitable form for projecting a carrier wave (e.g., electromagnetic energy) at the screen, modulating the carrier wave through movement of the screen, and then detecting the modulated carrier wave may be implemented.

Mirrors and/or light conduits may be used to direct light from the emitter 114, to the screen 102 and then to the light sensor 116. As may be appreciated, movement of the screen 102 at the edges may be smaller than at the center of the screen due to dampening effects from screen support structures. However, multiple sensors and or light sources may be implemented to increase sensitivity about the edges of the screen 102. For example, an array of sensors may be utilized and digital signal processing may be implemented to obtain a desired level of sensitivity.

Generally, the emitters 114 and sensors 116 are obscured by the bezel 104 (see FIG. 1) or are located behind the Z-stack of the display 101. As such, the emitters 114 and sensors 116 are generally not visible to a user of the computing device 100. The positioning of the emitters 114 and sensors 116 typically do not occlude the display screen 102. Furthermore, the close proximity of the emitters 114 and sensors 116 to the screen 102 allows for low power operation of the emitters. For example, in some embodiments, the emitters 114 may operate at or near 1 mW or less.

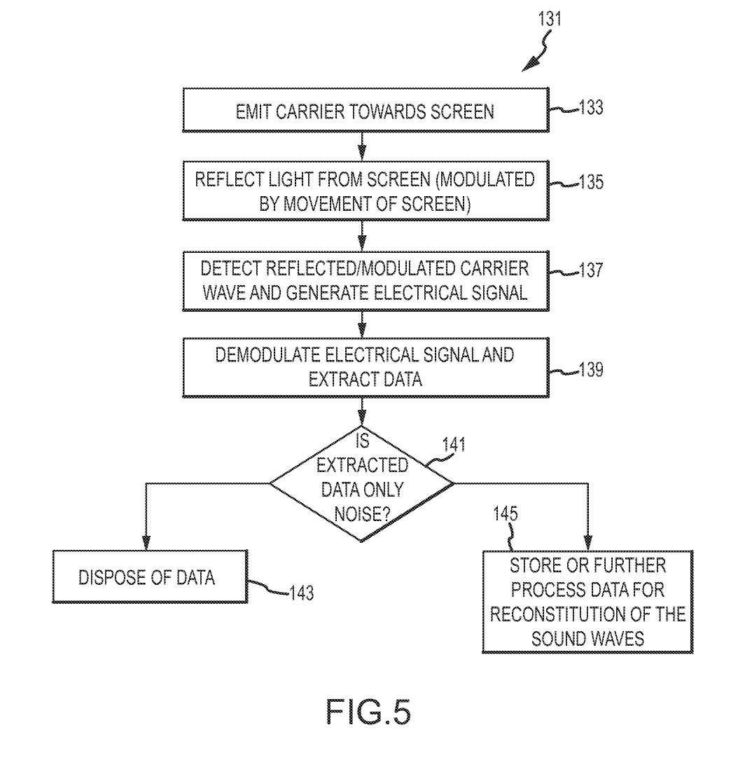

FIG. 5 is a flow chart illustrating a method 131 for indirectly sensing sound using the screen 102 as a diaphragm. Initially, the emitters 114 may emit carrier electromagnetic energy at the screen 102 (Block 133). The electromagnetic energy is reflected by the screen and movement of the screen modulates the carrier signal (Block 135). For example, the carrier signal is modulated by vibrations in the screen 102 caused by sound waves impacting the screen. The sensors 116 detect the modulated carrier signal and generate an electrical signal corresponding to the received modulated carrier signal (Block 137). The generated electrical signal is demodulated to extract data (Block 139).

In some embodiments, it may be determined if the extracted data contains only noise (Block 141). Known techniques may be implemented for the noise only determination and may include analysis as to amplitude, frequency and other characteristics of the extracted data. If the extracted data contains only noise, then the data may be disposed (Block 143). In some embodiments, active noise cancellation may be implemented. For example, there may be sensors (e.g., internal microphone, vibration sensor, and/or the like) used to sense internal noise levels, such as those from a hard disk drive or fan, and the signals from the sensors may be used to reject signals attributed to internal noise, thereby improving the signal-to-noise ratio. If the extracted data includes information other than noise, it may be stored or further processed for reconstitution of the sound waves that impacted the screen (Block 145).

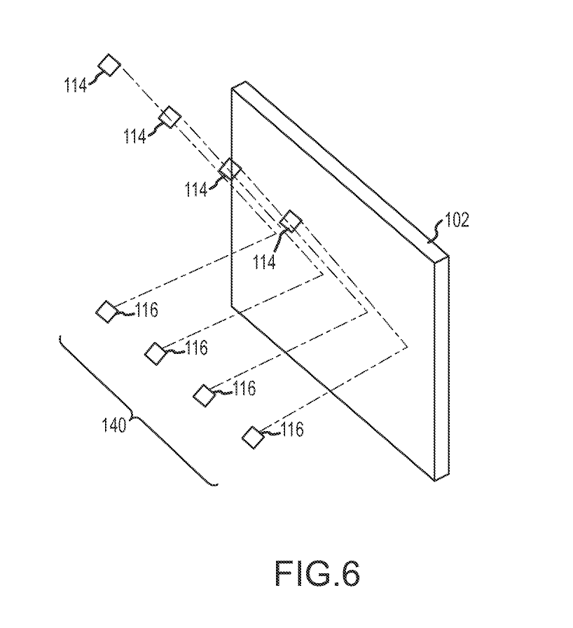

FIG. 6 illustrates an array 140 of sensors 116 receiving light reflected from the screen 102. In particular, emitters 114 are configured to direct light through gaps in between the pixels (not shown) which is reflected back to the sensors 116. Generally, light reflected from the center of the screen or near the center of the screen will provide a better signal to noise ratio when compared to those from the edges of the screen. In some embodiments, a dead pixel may be provided to allow electromagnetic energy emitted from the emitters 114 to reach the screen unobstructed.

It should be appreciated that the emitters 114 and sensors 116 may be distributed in any suitable manner. For example, they may be distributed around the entire screen 102, or they may be strategically located, such as near the horizontal and vertical center points. Additionally, there may be more than one sensor corresponding to a single source and the ratios of the sources to sensors may be different depending on where they are located on the screen.

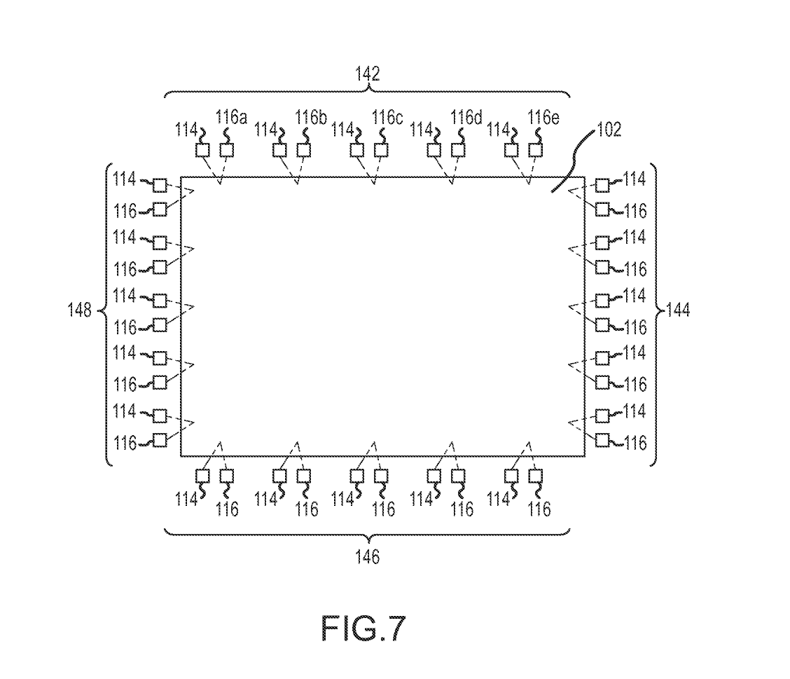

FIG. 7 illustrates an embodiment having arrays of sensors 142, 144, 146, 148 about the perimeter of the screen 102. The output of each of the sensors 116 in the array may be provided to the DSP 118 (FIG. 1) for processing of the received light signals. The processing may include computing a reverse phase array to retrieve lower frequency components of the reflected signal, as well as beamforming to provide directional selectivity, as discussed in greater detail below.

The modulated signals received by the sensors 116 generally do not contain low frequency components. This may be due to the physical characteristics of the screen 102 that may result in a relatively small displacement of the screen and/or other factors. The low frequency components may be retrieved based in part upon the spatial separation of the sensors 116. Hence, an array of sensors allows for extraction of more information for the various input signals to derive the composite signal 152.

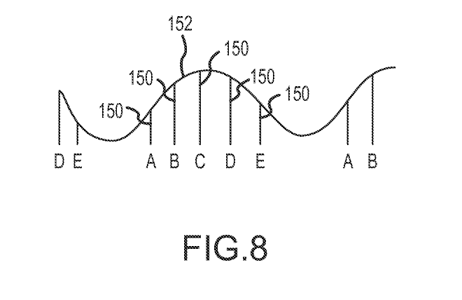

Referring to the array 142 which includes sensors 116a-e, due to their spatial separation, each sensor 116a-e will receive a phase shifted signal relative to the other sensors and/or a different volume. FIG. 8 illustrates the different volume levels 150 of the sensors 116 a-e. From the different volume levels and the phase difference information, a sine wave 152 may be generated that represents the low frequency component of the signal. It should be appreciated that a lowest signal that may be detected by the phased array will be limited by the largest distance between the sensors (e.g., the distance between 116a and 116e will define the lowest frequency that may be detected). Besides providing for derivation of the composite signal, the use of the array of sensors will generally serve two purposes: improving the signal-to-noise ratio by summing inputs from many sensors, and using phased array techniques to determine direction.

The array of sensors 142 also allows for beamforming of the incoming signal to achieve spatial selectivity. This may allow for gains in the sensitivity of the optical microphones created using the screen 102 sound wave receiver, similar to a diaphragm in a conventional microphone. The beamforming may be implemented as a fixed beamformer, adaptive beamformer, or a combination of the two. In the fixed beamformer embodiment, the beamforming may be utilized to improve the signal to noise ratio of the received signal based on the known physical properties (e.g., spatial separation) of the sensor array. In adaptive beamforming embodiments, the signals received by the sensors may be utilized in addition to the known physical properties of the array to determine how to treat the sensor output. Criteria related to noise rejection and/or signal amplitude, for example, may be utilized in determining the treatment of the output of the various sensors. Beamforming may be performed in the DSP 118 to achieve a desired level of sensitivity to sound waves that impact the screen 102.

One implementation of beamforming may include a real-time audio/video conference with multiple users that allows for selective, directional biasing of a received audio signal. That is, for example, if two people are talking at a single computing device and are displaced laterally relative to each other, steering of the received signals may be implemented to increase the sound received from one side of the computing device (e.g., sounds from the first user) and/or decrease the sound from the other side of the computer (e.g., sound from the second user).

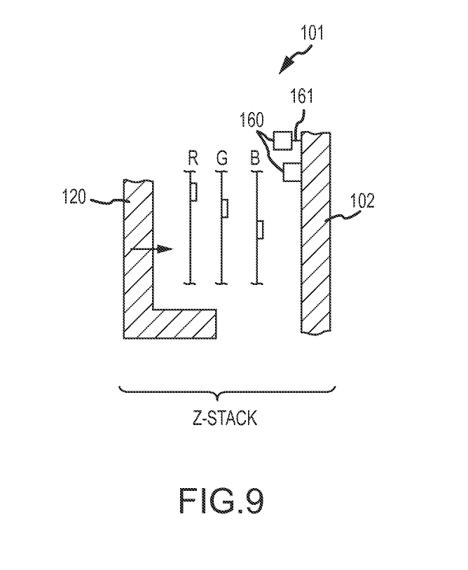

Other technologies may be implemented to sense vibrations of the screen 102 due to sound waves impacting the screen. For example, piezoelectric vibration sensors 160 may be used to sense the vibrations of the screen 102 in accordance with an alternative embodiment, as shown in FIG. 9. In some embodiments, the vibration sensors 160 may be directly coupled to the screen 102 and/or coupled to a post 161 (or other member) that is coupled to the screen. The coupling of the sensor 160 to the post 161 may enable increased sensitivity to vibrations in the screen 102, thus increasing the sound sensing abilities.

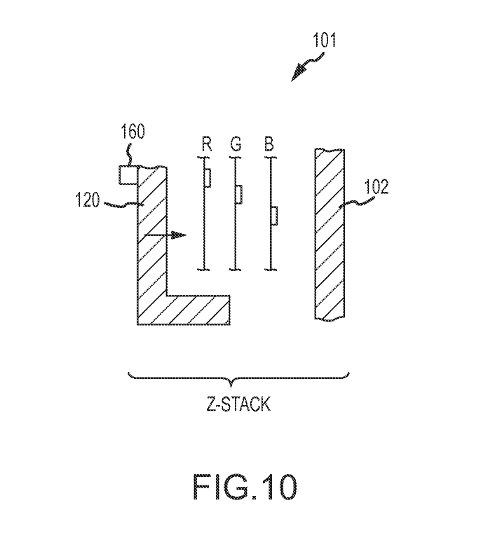

These vibration sensors 160 are relatively small (e.g., approximately 1 mm or smaller) and may be located at various positions within the stack of the display 101. For example, the sensors 160 may be located directed behind the screen 102. In other embodiments, the sensor 160 may be located behind the stack in accordance with another alternative embodiment, as shown in FIG. 10. Positioning the sensor 160 behind the stack may be beneficial when the layers of the display 101 are glued together such that vibrations of the screen are translated through the various layers. Additionally, the vibration sensors may be implemented when there are air gaps on the glass without significant adverse effects.

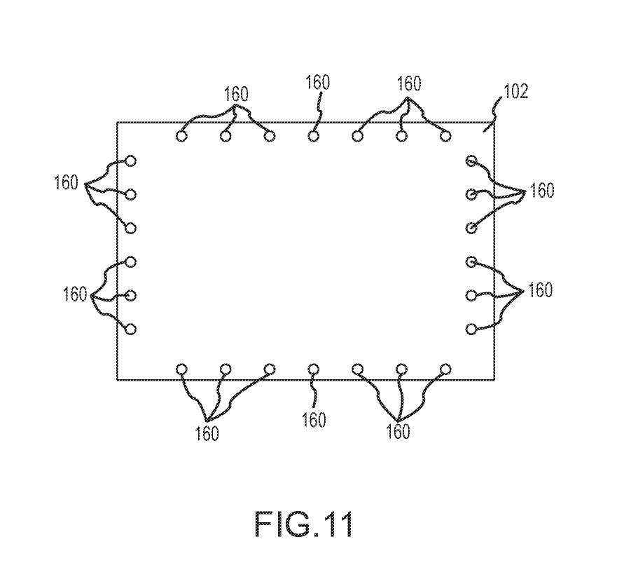

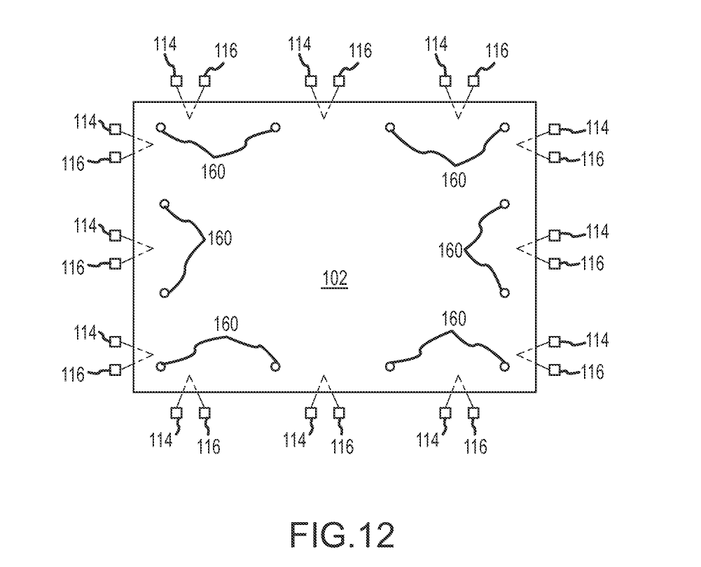

As with light-based sensors, the direct vibration sensors may be arranged in arrays, as shown in FIG. 11, so that beamforming, reverse phase array, and/or other techniques may be implemented. Moreover, the light based sensor and direct vibration sensors may be implemented together in a single system, as shown in FIG. 12. In some embodiments, one or both of the light based sensors and/or the vibration based sensor may be implemented in conjunction with conventional microphones to improve sound detection (e.g., improve signal to noise ratio, eliminate noise signals, and so forth).

Active noise reduction techniques may be implemented to increase the sensitivity of the microphone by eliminating effects of mechanical noise sources. The mechanical noises may come from a hard disk drive, a fan, or other mechanical devices whose operation may cause vibration. Sensors may be configured to detect the vibrations of these devices and the noise generated by them may be actively canceled out. That is, for example, a noise signal generated by the mechanical devices may be correlated with a portion of the optical signal received by the sensors 116. The noise is characterized in real-time and canceled out. This correlated signal is removed as noise from the signal received by the sensors 116 to improve a signal to noise ratio.

As discussed above, the sensors 116 may be implemented within the stack of the display 101 or about the edges of the screen and independent of the display stack. In some embodiments, the determination as to the position of the emitters 114 and sensors 116 may depend upon a number of factors. For example, the display stack may be a closed unit and inaccessible so the emitters 114 and sensors 116 may be positioned outside the stack. In other embodiments, the added depth of the emitter 114 and sensor 116 may be undesirable.

Further, in some embodiments, the positioning of the emitters and sensors may depend in part upon the support structure of the screen 102. For example, the cover glass of the screen 102 may be glued to the stack with the emitters 114 and the sensors 116 also glued into positions about the peripheral of the screen. However, the gluing may introduce some dampening.

Minute changes or deflections of the screen may be detected and a variety of applications may be introduced. For example, the emitters 114 and sensors 116 may be utilized for detecting ambient sound. The detected ambient sound may be used for improving generation of and/or detection of audio signals, as the vibrations may be filtered out of a received signal and/or accounted for when generating signals. Thus, this system may be used in addition to traditional microphones as a way to reject ambient noise for those traditional microphones to work better.

Moreover, static torques in the screen 102 may be measured. In particular, torque applied to the screen will cause the screen to deflect, thereby changing the signal reflected from the screen. This may be used to detect damage to the screen, in some embodiments. Additionally, the opening or closing of the screen 102 in the computing device 100 may be determined based on the torque applied to the screen during such actions. As such, the computing device may be woken up or put into a “sleep mode” based on the sensed signals.

The audio sensor discussed herein may be implemented in touch screen computing devices as well as non-touch screen devices. In embodiments having a touch screen, touching the screen by a user may generate an impulse input signal (for example, when the screen is tapped) which may be treated as noise to be canceled out. The impulse input may canceled out at least in part using the signal indicating the screen has been touched. That is, when a relatively large signal is sensed by a light-based sensor or a direct vibrations sensor concurrently with a touch input, the large signal may be ignored or canceled out as having been related to the touch input.

Additionally, touching the screen by a user may dampen the vibrations of the screen (for example, when the user rests a finger/hand on the screen). When a movement of the screen 102 is dampened due to a user's finger/hand touching the screen 102, the determination that the screen is being touched (e.g., there is touch input) may trigger an amplification routine that attempts to amplify the signals of the sensors 116. In some embodiments, the location where the screen is touched may be determined and sensors located furthest away from that location may be used, as they would be least impacted by the dampening. Also, an indication from the touch sensors that the screen is being touched may be used to reject any audio input from the screen as being corrupted. Thus, the system can gate sound sensor input.

In some embodiments, isolation techniques may be implemented to limit cross-talk between emitter and sensor pairs. For example, light absorbing or scattering material may be positioned between emitter and sensor pairs.

The foregoing describes some example embodiments for utilizing a display screen of a computing device as a diaphragm for audio sensing. Although specific embodiments have been presented, persons skilled in the art will recognize that changes may be made in form and detail without departing from the spirit and scope of the embodiments. For example, surfaces other than a computer screen may be utilized as a diaphragm and the techniques included herein may be implemented in devices other than a conventional computer. That is, the indirect light-based sensors and/or direct vibration sensors may be implemented in a display of a car, for example. In this embodiment, the display may act as the diaphragm and the sensors may be configured to sense and interpret voice commands while driving. Further, using the spatial determination capabilities may allow for commands from a passenger to be directed to the passenger side of the vehicle, while commands from a driver may be applied to the entire vehicle or the driver's side only, as the case may be. This may be applied, for example, to voice control of a climate control system of the vehicle.

Another example implementation may be in a helmet with a heads-up display. Here, a visor may be used as a diaphragm in conjunction with the direct or indirect sensors for sensing and interpreting the user's discussion and/or voice commands. In yet another example implementation, a screen of a television set may be used as a diaphragm for sound sensing. In one embodiment, the sound sensing may be used in a feedback loop to adjust the volume of the television set when someone is talking or when there is high volume of ambient noise. For example, the television may turn down its volume when someone is talking and may increase its volume when there is a high level of ambient noise.

Other possible implementations of the sound sensors set forth herein may be possible. Accordingly, the specific embodiments described herein should be understood as examples and not limiting the scope thereof.

1. An audio detection system comprising:
a display assembly comprising:
a screen;
at least one electromagnetic energy emitter configured to direct energy at an inside surface of the screen; and
at least one sensor configured to sense the emitted energy after it is reflected from the inside surface of the screen and generate electrical signals corresponding the sensed reflected energy; and
a processor coupled to the at least one sensor, wherein the processor generates an audio signal representative of sound waves that impact an outer surface of the screen.

2. The audio detection system of claim 1, wherein the at least one electromagnetic energy emitter comprises a plurality of emitters arranges in an array.

3. The audio detection system of claim 2, wherein the plurality of emitters are positioned near one or more edges of the screen.

4. The audio detection system of claim 2, wherein at least one of the plurality of emitters is configured to direct energy at or near a center of the screen.

5. The audio detection system of claim 1, wherein the at least one electromagnetic energy emitter is configured to direct energy near a center of the screen.

6. The audio detection system of claim 1, wherein the at least one electromagnetic energy emitter is configured to direct energy near an edge of the screen.

7. The audio detection system of claim 1, wherein the at least one electromagnetic energy emitter is configured to emit energy in one of the RF band, the visible spectrum, or the infrared spectrum.

8. The audio detection system of claim 1, wherein the light emitter comprises one of a laser diode or a light emitting diode.

9. The audio detection system of claim 1, wherein the display comprises a liquid crystal display.

10. The audio detection system of claim 1, wherein the processor is configured to provide beamforming functionality.

11. A computer system comprising:
a display comprising:
a screen having an interior surface and an exterior surface; and
one or more sensors coupled to the display and configured to detect vibrations of the screen generated by sound waves impacting the exterior surface of the screen; and
a processor in communication with the one or more sensors configured to generate an output representative of sound waves.

12. The computer system of claim 11, wherein the one or more sensors comprise an array of piezoelectric vibration sensors.

13. The computer system of claim 12, wherein the array of piezoelectric sensors are coupled to the screen.

14. The computer system of claim 12, wherein the display comprises a plurality of layers, the screen being one of the layers and wherein further the array of piezoelectric sensors are coupled to a layer other than the screen.

15. The computer system of claim 11 further comprising one or more emitters coupled to the display and wherein the one or more sensors comprise electromagnetic energy sensors.

16. The computer system of claim 15 wherein at least one of the one or more emitters is directed at or near a center of the screen.

17. The computer system of claim 15 wherein at least one of the one or more emitters is directed at or near and edge of the screen.

18. A method of operating a computing device comprising:
obtaining an electrical signal corresponding to vibration of a screen of the computing device resulting from sound waves impacting the screen;
filtering the signal to remove noise components; and
generating an output signal representative of the sound waves that impacted the screen.

19. The method of claim 18, wherein obtaining an electrical signal comprises:
directing electromagnetic energy at an interior surface of the screen from at least one emitter; and
sensing a portion of the electromagnetic energy reflected from the interior surface of the screen with at least one sensor.

20. The method of claim 18, wherein obtaining an electrical signal comprises sensing vibration of the screen using a plurality of piezoelectric vibration sensors distributed about a periphery of the screen.

21. The method of claim 18 wherein generating an output signal representative of the sound waves comprises reconstructing a portion of an audible spectrum using a reverse phase array technique.

22. The method of claim 18 wherein generating an output signal representative of the sound waves comprises performing beam steering techniques to improve a signal to noise ratio.
